(19) United States
(12) Patent Application Publication
(10) Pub. No.: US 2024/0275019 A1
(43) Pub. Date: Aug. 15, 2024

(54) A MOUNTING SYSTEM

(71) Applicant: EVOLUTIONARY RAIL LIMITED, London (GB)

(72) Inventors: Peter Hansen, Coalville (GB); Matthew Turner, Coalville (GB); Ebby Shahidi, Coalville (GB); Simon Holmes, London (GB)

(73) Assignee: EVOLUTIONARY RAIL LIMITED, London (GB)

(21) Appl. No.: 18/571,456

(22) PCT Filed: Jun. 17, 2022
(86) PCT No.: PCT/GB2022/051538

§ 371 Date: Dec. 18, 2023

(30) Foreign Application Priority Data
Jun. 18, 2021 (GB) 2108815.8

(51) Int. Cl. H01Q 1/12; H01Q 3/06

(52) U.S. Cl. CPC H01Q 1/1228; H01Q 3/06

(57) ABSTRACT

A mounting system for telecommunications equipment comprises: a mast for supporting telecommunications equipment; a first mounting bracket, affixable to supporting infrastructure; a pivot, secured to the first mounting bracket, into which a first end of the mast is mounted, the pivot enabling the mast to be pivoted between a first, raised position and a second, lowered position; and a second mounting bracket, affixable to the supporting infrastructure, for selectively supporting the mast while in the first position.

### TECHNICAL FIELD

Embodiments of the present disclosure relate to a mounting system, and particularly to a mounting system for telecommunications equipment.

### BACKGROUND

Equipment such as telecommunications, radio, weather-stations, CCTV and the like typically operate best when installed at a height above ground level.

In some instances, it is difficult, dangerous and/or costly to install such equipment at height. For example, recent developments in the field of telecommunications have the goal of providing high-bandwidth, low-latency radio connectivity to vehicles such as cars and trains, which may be moving at high speeds. In order to provide such radio connectivity, it is advantageous to position the network infrastructure as close as possible to the vehicles themselves, and hence as close as possible to the road or track.

Clearly, the telecommunication equipment should be positioned such that there is no risk of collision with a vehicle when in use. However, there are also safety concerns for engineers installing or maintaining the network infrastructure, due to the close proximity of vehicles and potentially other transport infrastructure such as overhead electrical cables, etc.

### SUMMARY

Embodiments of the disclosure seek to address these and other problems by providing a mechanism which enables telecommunication equipment to be installed on a mast affixed to network infrastructure at a safe working height, and then safely raised to a higher operating position and secured in place.

According to an aspect of the disclosure, there is provided a mounting system for telecommunications equipment. The system comprises: a mast for supporting telecommunications equipment; a first mounting bracket, affixable to supporting infrastructure; a pivot, secured to the first mounting bracket, into which a first end of the mast is mounted, the pivot enabling the mast to be pivoted between a first, raised position and a second, lowered position; and a second mounting bracket, affixable to the supporting infrastructure, for selectively supporting the mast while in the first position

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows a mounting system according to embodiments of the disclosure;

FIG. 2 shows part of the mounting system according to embodiments of the disclosure;

FIG. 3 shows a lower mounting bracket according to embodiments of the disclosure;

FIG. 4 shows another part of the mounting system according to embodiments of the disclosure;

FIG. 5 shows a cross-section of a mast according to embodiments of the disclosure;

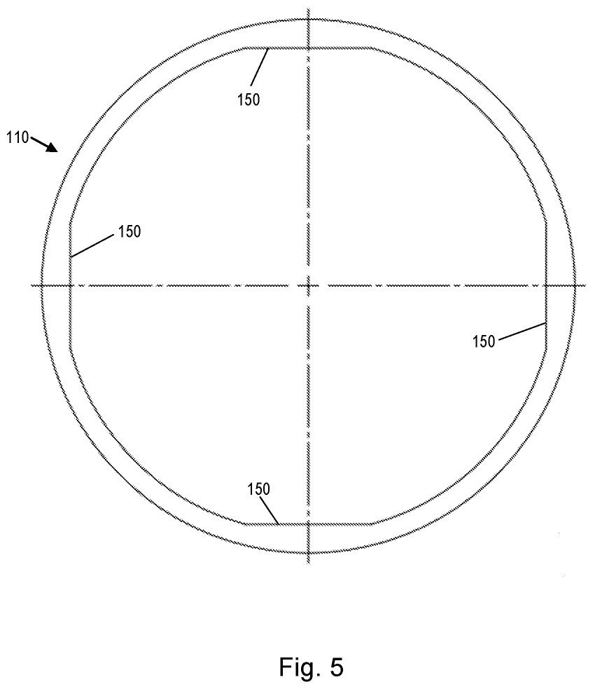

FIG. 6 shows the mounting system according to embodiments of the disclosure, in which the mast is pivoted to a lower position; and

FIG. 7 shows a system according to embodiments of the disclosure.

### DETAILED DESCRIPTION

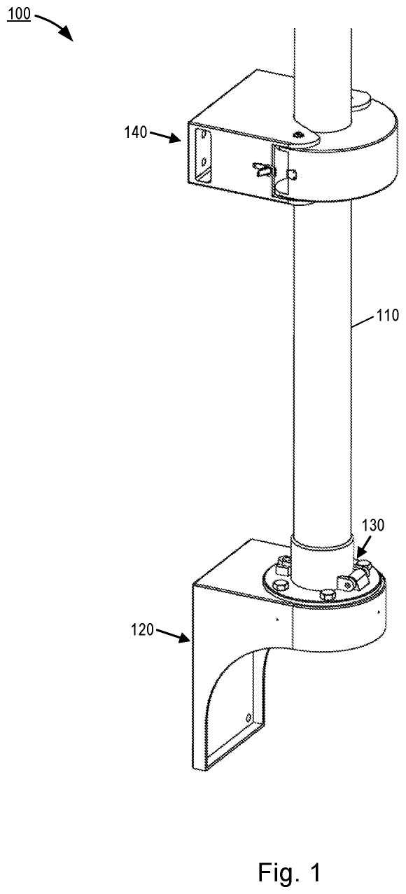

FIG. 1 shows a mounting system 100 according to embodiments of the disclosure. The mounting system 100 provides a mechanism for mounting telecommunications equipment (e.g., antennas) and the like (e.g., weather stations, closed-circuit television cameras, etc) to a support or infrastructure.

The mounting system 100 comprises a mast 110, a first mounting bracket 120, a pivot 130 and a second mounting bracket 140. In use, the mast 110 may be oriented substantially vertically, such that the first mounting bracket 120 is positioned at a relatively low height, and the second mounting bracket 140 is positioned at a relatively high height. For this reason, the first mounting bracket 120 may be referred to in the following as “the lower mounting bracket”, and the second mounting bracket 140 may be referred to in the following as “the upper mounting bracket”.

According to embodiments of the disclosure, one end of the mast 110 is mounted into the pivot 130. The pivot 130 enables the mast to be pivoted between a first, raised position (e.g., vertical) and a second, lowered position (e.g., non-vertical). The upper mounting bracket 140 supports the mast 110 while in the first position, and can selectively release the mast 110 so as to permit pivoting to the second position.

Embodiments of the disclosure thus provide a simple, robust and safe mechanism for mounting telecommunications equipment and the like to infrastructure. When in the lowered position, the mast 110 is at a height which enables equipment to be mounted towards its upper end, and/or equipment already mounted on the mast to be maintained by engineers standing on the ground. The mast can then be lifted to the first position and secured in place by the upper mounting bracket. In this way, telecommunications equipment, which usually operates at height, can be installed and maintained in a safe manner. Further, through the use of lightweight materials, such installation and maintenance can be carried out by a small team of engineers (e.g., two people) without the need for heavy lifting equipment.

Further detail regarding the embodiments of the disclosure is provided below.

The lower and upper mounting brackets 120, 140 each comprise mounting plates which, in use, are applied and affixed to the infrastructure. In the illustrated embodiment, the mounting plates are substantially flat (planar) and therefore suitable for attachment to a substantially flat surface of the infrastructure. Those skilled in the art will appreciate that the mounting plate(s) may be shaped in any suitable manner, dependent on the shape and dimensions of the infrastructure, so as to provide a robust connection between the mounting system and the infrastructure. Through-holes in the mounting plates enable fixing devices (such as bolts) to be inserted through the mounting plates and fixed to the infrastructure.

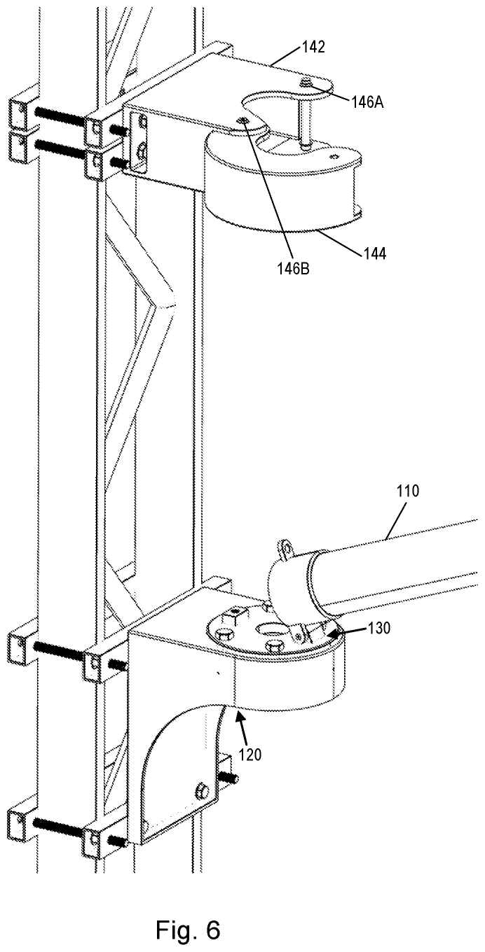

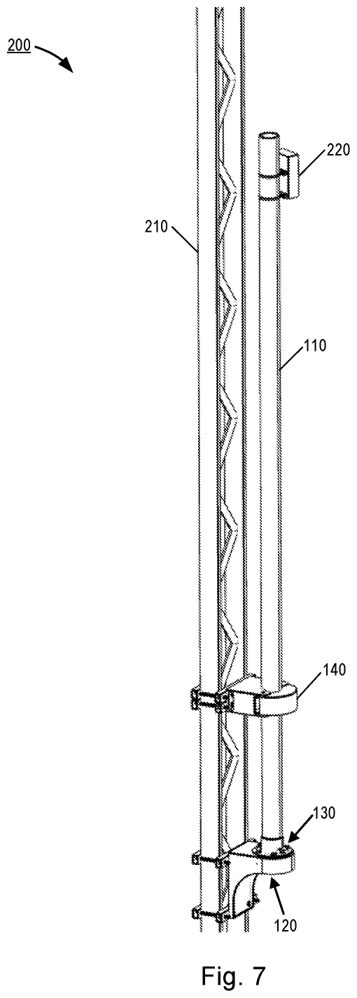

In one embodiment, shown in more detail with respect to FIGS. 6 and 7, the mounting brackets 120, 140 are clamped to the infrastructure through the use of clamping plates positioned on an opposing surface of the infrastructure and bolts extending between the mounting plates the clamping brackets.

The pivot 130 comprises a socket 132, a pivot mounting plate 134 and a pivot point 136. The socket 132 has an internal profile that corresponds in shape and size to an external profile of the mast 110. One (lower) end of the mast 110 is inserted into the socket 132. The lower end of the mast 110 may be affixed into the socket 132 through any suitable mechanism, such as the use of adhesive, clamping, fixing devices, etc. The mechanism which is chosen may depend on the materials of the mast. For example, in one embodiment the mast 110 is manufactured from composite materials such as fibre-reinforced polymeric materials. In such an embodiment, adhesive may be used to avoid placing undue stress on the mast itself.

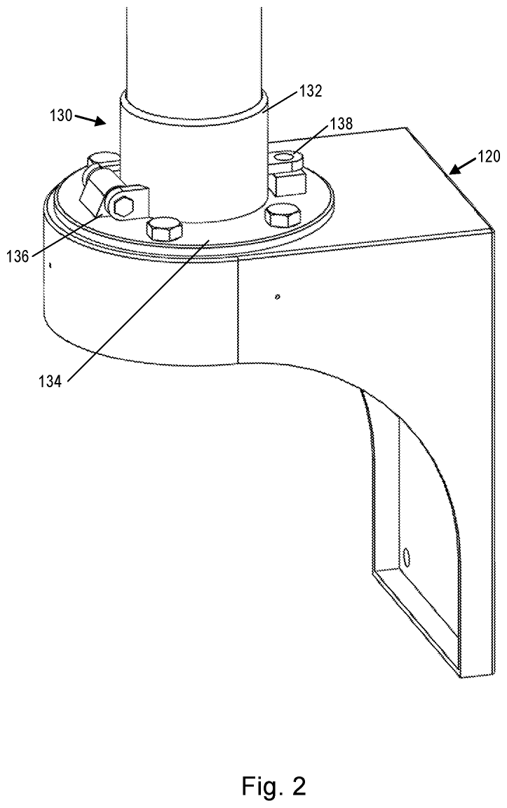

As may best be viewed in FIG. 2 and FIG. 6, the socket 132 is connected to the pivot mounting plate 134 via the pivot point 136. The pivot point 136 permits the mast 110 to be pivoted with respect to the pivot mounting plate 134 between the first position (e.g., vertical, see FIG. 2) and a second position at which the upper end of the mast 110 is accessible from the ground (e.g., non-vertical, see FIG. 6).

According to some embodiments of the disclosure, a pivot lock 138 is provided on the pivot mounting plate 134 and a side of the socket 132 which opposes the pivot point 136. The pivot lock 138 secures the pivot 130 and the mast 110 in the first position (e.g., vertical), and prevents movement of the mast 110 from the first position to the second position. In the illustrated embodiment, the pivot lock comprises a bolt which passes, in a direction substantially parallel to the axis of the mast, through an eyelet provided on the side of the socket 132 and a co-located hole (not visible in the drawings) in the pivot mounting plate 134. By securing the bolt between the eyelet and the hole in the pivot mounting plate 134, pivoting movement of the mast 110 is prevented. For example, the co-located hole may be threaded such that the bolt is brought into threaded engagement with the hole. In alternative embodiments, the pivot lock 138 may comprise a pin which passes horizontally (e.g., substantially perpendicular to the axis of the mast) through eyelets mounted on the socket 132 and the pivot mounting plate 134. Those skilled in the art will appreciate that further alternative mechanisms are possible, such as a latch.

In some embodiments of the disclosure, the pivot 130 is rotatable with respect to the lower mounting bracket 120 about an axis that is substantially parallel to the longitudinal axis of the mast 110. The rotation angle may be adjustable between set limits via slots machined into the lower bracket.

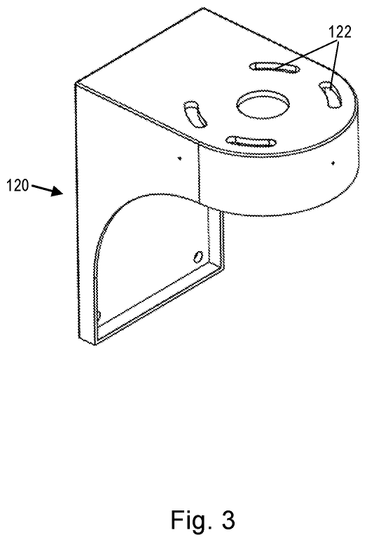

This mechanism is best described with respect to FIG. 2 and FIG. 3, which shows the lower mounting bracket 120 with the pivot 130 removed. The lower mounting bracket 120 comprises a plurality of partial circular slots 122 positioned around the rotational axis of the mast 110. Bolts 124 pass through holes in the pivot mounting plate 134, and engage with the slots 122. While the bolts 124 are loose, they are able to move within the slots 122 such that the pivot 130 rotates with respect to the lower mounting bracket 120. The extent of the rotation is defined by the length of the slots 122. When the bolts are tightened, the pivot 130 is fixed rotationally with respect to the lower mounting bracket 120. Thus the angle of the pivot 130 with respect to the lower mounting bracket 120 can be defined as necessary for the terrain and topography in which the mounting system 100 and the infrastructure are located, and then locked in place to ensure safe raising and lowering of the mast 110. Where the mounting system 100 is used near railways or roads, for example, the angle may be defined such that the mast 110 is lowered in a direction away from or parallel to the railway, the road and/or other dangerous items such as overhead cables. Furthermore, this angle is adjustable after installation should the mast 110 need to be lowered into a different position from which it was raised.

The lower mounting bracket 120 may be positioned, in use, at a safe working height for engineers standing on the ground, with the upper mounting bracket 140 positioned a distance above the lower mounting bracket 120 (e.g., between 0.5 and 2 metres above the lower mounting bracket, depending on the overall length of the mast 110).

While the mast 110 is in the first position, the upper mounting bracket 140 surrounds and supports the mast 110 at a location along the mast's length which is displaced from the pivot 130. By providing a second support some way along the length of the mast, bending moments and deflections are reduced, the structure is stiffened, and stress in the mast is reduced. In addition, the upper mounting bracket 140 reduces the stress and bending moment into the infrastructure on which the system 100 is mounted, increasing the opportunity to mount the system 100 on different types of infrastructure.

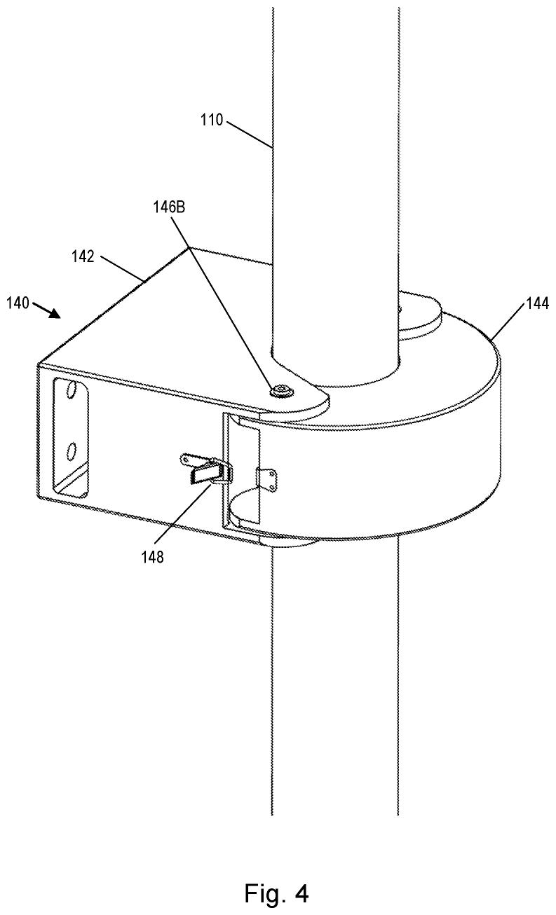

As may be seen best in FIG. 4 and FIG. 6, the upper mounting bracket 140 comprises a fixed section 142 and a movable section 144 that is moveable with respect to the fixed section 142. The movable section 144 is closable around the mast 110 so as to support the mast 110 while the mast is in the first position (see FIG. 4). The movable section 144 is openable so as to release the mast 110 from the upper mounting bracket 140, and permit the mast 110 to move (e.g., pivot) to the second position (see FIG. 6).

The movable section 144 is attached to the fixed section 142 using one or more closing mechanisms. A primary closing mechanism comprises first and second pins 146A, 146B inserted through holes in the fixed section 142 and the movable section 144 on either side of the mast 110. To release the mast 110 from the upper mounting bracket 140, one or both pins 146A, 146B are removed such that the movable part 144 no longer encloses the mast 110. For convenience (and as shown in FIG. 6), only one pin (e.g., the first pin 146A) may be removed from the movable section 144 while the other (e.g., the second pin 146B) is maintained in position. In this way, the remaining pin enables the movable section 144 to swing away from the mast 110 and permit its movement to the second position. One or more secondary closing mechanisms 148 may be provided to assist in holding the movable section 144 in place (e.g., while the pins 146A, 146B are installed). In the illustrated embodiment, the secondary closing mechanisms 148 comprise toggle latches. However, those skilled in the art will appreciate that alternative closing mechanisms may be provided and the present disclosure is not limited in that respect.

While the mast 110 is held by both lower and upper mounting brackets 120, 140 (e.g., in the first position), the mast may have a fixed horizontal spacing with respect to the infrastructure.

In the illustrated embodiment, the mast 110 has a substantially circular cross-section, such that the socket 132 and the opening in the upper mounting bracket 140 are also substantially circular. Those skilled in the art will appreciate that the mast 110 may have any suitable cross-sectional shape. In some embodiments of the disclosure, the mast 110 is hollow and shaped internally (e.g., with flats or a suitable profile) to accommodate fixing of equipment and to minimise movement under wind load. That is, the internal profile may comprise a different shape to the external circular section, to increase the efficacy of the mount between the mast 110 and any equipment mounted thereto. FIG. shows one example in which the mast 110 comprises four separate flat sections 150 in its internal profile. Equipment mounted on the mast 110 may be secured against these flat sections 150, which increase the resistance of the equipment to rotation around the mast under sideways load (e.g., from wind).

In some embodiments, electrical wires and cabling to and from any equipment mounted on the mast 110 may be routed inside the mast 110, so as to reduce the likelihood of weathering or accidental damage to the cabling. For example, the cabling may be routed through one or more openings at the end of the mast 110 or provided in a sidewall of the mast.

Any one or more of the mast 110, the lower mounting bracket 120 and the upper mounting bracket 140 may be made from fibre reinforced polymeric materials or other composite materials. These materials have the advantages of being electrically non-conductive (thus having electrical safety during installation and use), lightweight (allowing for manual handling without vehicles to carry the system 100), and low maintenance (resistant to corrosion and fatigue).

Although not illustrated, in some embodiments the system 100 may comprise one or more mechanisms to reduce the amount of force required to lift the mast 110 from its second, lower position to the first, operational position. For example, one or more gas struts or springs may be provided between a movable part of the system (e.g., the mast 110) and a fixed part of the system (e.g., the lower or upper mounting bracket, and/or the infrastructure).

FIG. 7 shows a system 200 according to embodiments of the disclosure. The system 200 comprises infrastructure 210, a mounting system 100 substantially as described above, and equipment 220 mounted to an upper end of the mast 110. In the illustrated embodiment, the equipment 220 comprises one or more antennas.

In the illustrated embodiment, the infrastructure 210 consists of a frame having two vertical beams and a plurality of angles crossbeams extending between the vertical beams and providing the frame with rigidity. Those skilled in the art will appreciate that the infrastructure may take any suitable shape and may be provided for any purpose. For example, the infrastructure 210 need not be dedicated to the support of the mounting system 100 and its equipment, but may be provided for other purposes. That is, the mounting system 100 may be affixed to any suitable structure and may, in some embodiments, re-use existing infrastructure.

Embodiments of the disclosure thus provide a simple, robust and safe mechanism for mounting telecommunications equipment and the like to infrastructure. The mechanism comprises a system of brackets and a mast, which are mountable onto infrastructure to carry telecommunications antennas and/or similar equipment. A pivot enables the mast to be lowered from a first, operational position, to a second, lower position, such that the equipment can be installed and maintained on the mast safely and at low cost while at ground level. An upper mounting bracket reduces bending moment (stress) on the mast, brackets and the infrastructure, lowers the deflection of the mast due to wind and equipment, and stiffens the structure.

Variations to the disclosed embodiments can be understood and effected by those skilled in the art in practicing the principles and techniques described herein, from a study of the drawings, the disclosure and the appended claims. The word “comprising” does not exclude other elements or steps, and the indefinite article “a” or “an” does not exclude a plurality. A single component or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A mounting system for telecommunications equipment, the system comprising:
a mast for supporting telecommunications equipment;
a first mounting bracket, affixable to supporting infrastructure;
a pivot, secured to the first mounting bracket, into which a first end of the mast is mounted, the pivot enabling the mast to be pivoted between a first, raised position and a second, lowered position; and
a second mounting bracket, affixable to the supporting infrastructure, for selectively supporting the mast while in the first position.

2. The mounting system according to claim 1, wherein the pivot is rotatable relative to the first mounting bracket such that the mast is rotatable about its longitudinal axis.

3. The mounting system according to claim 2, wherein the first mounting bracket comprises a limiting mechanism restricting rotation of the pivot between limits.

4. The mounting system according to claim 3, wherein the limiting mechanism comprises one or more slots machined in the first mounting bracket.

5. The mounting system according to claim 1, wherein the second mounting bracket comprises a section that is closable around the mast to support the mast while in the first position, and openable to enable the mast to be pivoted to the second position.

6. The mounting system according to claim 1, wherein one or more of the mast, the first mounting bracket and the second mounting bracket are manufactured from one or more electrically non-conductive materials.

7. The mounting system according to claim 6, wherein the electrically non-conductive materials comprise fibre-reinforced polymeric materials.

8. The mounting system according to claim 1, wherein an internal profile of the mast has one or more flat sections for the mounting of telecommunication equipment.

9. The mounting system according to claim 1, wherein the mast has a circular cross-section.

10. A system comprising:
supporting infrastructure;
a mounting system according to claim 1, wherein the first and second mounting brackets are affixed to the supporting infrastructure; and
telecommunication equipment mounted to the mast.

11. The system according to claim 10, wherein the telecommunication equipment comprises one or more antennas.

12. The system according to claim 10, wherein the first and second mounting brackets are clamped to the supporting infrastructure.
